(19) United States
(12) Patent Application Publication
(10) Pub. No.: US 2025/0097988 A1
(43) Pub. Date: Mar. 20, 2025

(54) COVERAGE ENHANCEMENT METHOD AND RELATED DEVICES

(71) Applicant: SHENZHEN TCL DIGITAL TECHNOLOGY LTD., Shenzhen (CN)

(72) Inventor: Yiwei DENG, Shenzhen (CN)

(73) Assignee: SHENZHEN TCL DIGITAL TECHNOLOGY LTD., Shenzhen (CN)

(21) Appl. No.: 18/729,521

(22) PCT Filed: Jan. 19, 2022
(86) PCT No.: PCT/CN2022/072816

§ 371 Date: Jul. 17, 2024

(51) Int. Cl. H04W 74/0833

(52) U.S. Cl. CPC H04W 74/0833

(57) ABSTRACT

A coverage enhancement method, performed by a user equipment (UE) communicating with a base station (BS), includes transmitting Physical Random Access Channel (PRACH) repetitions in random access transmission occasions and monitoring random access response (RAR) from the base station within one or more random access response windows determined based on the PRACH repetitions.

### TECHNICAL FIELD

The present application relates to wireless communication technologies, and more particularly, to a coverage enhancement method, and related devices such as a user equipment (UE) and a base station (BS) (e.g., a gNB).

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN includes a set of base stations (BSs) which provide wireless links to the UEs located in cells covered by the base stations, and an interface to a core network (CN) which provides overall network control. The RAN and CN each conducts respective functions in relation to the overall network.

The 3GPP has developed the so-called Long-Term Evolution (LTE) system, namely, an Evolved Universal Mobile Telecommunication System Territorial Radio Access Network (E-UTRAN), for a mobile access network where one or more macro-cells are supported by base station knowns as an eNodeB or eNB (evolved NodeB). More recently, LTE is evolving further towards the so-called 5G or NR (new radio) systems where one or more cells are supported by base stations known as a next generation Node B called gNodeB (gNB).

The 5G New Radio (NR) standard will support a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

Coverage is one of the key factors that an operator considers when commercializing cellular communication networks due to its direct impact on service quality as well as Capital expenditures (CAPEX) and Operating expenses (OPEX). Despite the importance of coverage on the success of NR commercialization, a thorough coverage evaluation and a comparison with legacy Radio Access Technologies (RATs) considering all NR specification details have not been done up to now.

Compared to LTE, NR is designed to operate at much higher frequencies such as 28 GHz or 39 GHz in FR2. Furthermore, many countries are making available more spectrums on FR1, such as 3.5 GHz, which is typically in higher frequencies than for LTE or 3G. Due to the higher frequencies, it is inevitable that the wireless channel will be subject to higher path-loss making it more challenging to maintain an adequate quality of service that is at least equal to that of legacy RATs. One key mobile application of particular importance is voice service for which a typical subscriber will always expect a ubiquitous coverage wherever s/he is.

For FR1, NR can be deployed either in newly allocated spectrums, such as 3.5 GHZ, or in a spectrum re-farmed from a legacy network, e.g., 3G and 4G. In either case, coverage will be a critical issue considering the fact that these spectrums will most likely handle key mobile services such as voice and low-rate data services. For FR2, coverage was not thoroughly evaluated during the self-evaluation campaign towards IMT-2020 submission and not considered in Rel-16 enhancements. In these regards, a thorough understanding of NR coverage performance is needed while taking into account the support of latest NR specification.

In 3GPP Rel-17, PRACH is identified as a bottleneck channel. Some proposed multiple PRACH transmissions with the same transmission beam or different beams. Unfortunately, due to time limitation, PRACH enhancement was not standardized. Potential methods of PRACH enhancement were proposed, but details were not discussed.

In RAN #94 meeting, a new Rel-18 work item on NR coverage enhancements was approved. The objective of this study item is to study potential coverage enhancement solutions for specific scenarios for both FR1 and FR2. The detailed objectives are as follows.
Specify following PRACH coverage enhancements (RAN1, RAN2)
   Multiple PRACH transmissions with same beams for 4-step RACH procedure
   Study, and if justified, specify PRACH transmissions with different beams for 4-step RACH procedure
   Note 1: The enhancements of PRACH are targeting for FR2, and can also apply to FR1 when applicable.
   Note 2: The enhancements of PRACH are targeting short PRACH formats, and can also apply to other formats when applicable.
Study and if necessary specify following power domain enhancements
   Enhancements to realize increasing UE power high limit for CA and DC based on Rel-17 RAN4 work on “Increasing UE power high limit for CA and DC”, in compliance with relevant regulations
      Note 1: The study starts after RAN4 work on “Increasing UE power high limit for CA and DC” is done depending on conclusions from RAN4.
      Note 2: The objective will be revisited and further clarified in RAN plenary after RAN4 work on “Increasing UE power high limit for CA and DC” is done, and the discussion in WGs will not start before the objective is revised with a clearer scope.
      Note 3: Both RAN1 and RAN4 are expected to be involved; to decide the order of either (RAN4, RAN1) or (RAN1, RAN4) later.
   Enhancements to reduce MPR/PAR, including frequency domain spectrum shaping with and without spectrum extension for DFT-S-OFDM and tone reservation
Specify enhancements to support dynamic switching between DFT-S-OFDM and CP-OFDM

There are still some issues need to carry out for coverage enhancement for uplink (UL) transmission.

### SUMMARY

The objective of the present application is to provide a coverage enhancement method and related devices, for carrying out coverage enhancement.

In a first aspect, an embodiment of the present application provides a coverage enhancement method, performed by a user equipment (UE) communicating with a base station (BS), the method comprising: transmitting Physical Random Access Channel (PRACH) repetitions in random access transmission occasions; and monitoring random access response (RAR) from the base station within one or more random access response windows determined based on the PRACH repetitions.

In a second aspect, an embodiment of the present application provides a coverage enhancement method, performed by a base station (BS) communicating with a user equipment (UE), the method comprising: receiving from the UE Physical Random Access Channel (PRACH) repetitions in random access transmission occasions; and expecting the UE to monitor random access response (RAR) from the base station within one or more random access response windows determined based on the PRACH repetitions.

In a third aspect, an embodiment of the present application provides a UE, communicating with a BS in a network, the UE including a processor, configured to call and run program instructions stored in a memory, to execute the method of the first aspect.

In a fourth aspect, an embodiment of the present application provides a BS, communicating with a UE in a network, the BS including a processor, configured to call and run program instructions stored in a memory, to execute the method of the second aspect.

In a fifth aspect, an embodiment of the present application provides a computer readable storage medium provided for storing a computer program, which enables a computer to execute the method of any of the first and the second aspects.

In a sixth aspect, an embodiment of the present application provides a computer program product, which includes computer program instructions enabling a computer to execute the method of any of the first and the second aspects.

In a seventh aspect, an embodiment of the present application provides a computer program, when running on a computer, enabling the computer to execute the method of any of the first and the second aspects.

### DESCRIPTION OF DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a schematic block diagram illustrating a communication network system according to an embodiment of the present application.

FIG. 2 is a flowchart of a coverage enhancement method according to an embodiment of the present application.

FIG. 3 is a schematic diagram illustrating an example of ra-Response Window according to an embodiment of the present application.

FIG. 4 is a schematic diagram illustrating another example of ra-Response Window according to an embodiment of the present application.

FIG. 5 is a schematic diagram illustrating yet another example of ra-Response Window according to an embodiment of the present application.

FIG. 6 is a schematic diagram illustrating yet another example of ra-Response Window according to an embodiment of the present application.

FIG. 7 is a schematic diagram illustrating yet another example of ra-Response Window according to an embodiment of the present application.

FIG. 8 is a schematic diagram illustrating yet another example of ra-Response Window according to an embodiment of the present application.

FIG. 9 is a schematic diagram illustrating yet another example of ra-Response Window according to an embodiment of the present application.

FIG. 10 is a schematic diagram illustrating a mapping between multiple beams and multiple repetition ROs according to an embodiment of the present application.

FIG. 11 is a schematic diagram illustrating another mapping between multiple beams and multiple repetition ROs according to an embodiment of the present application.

FIG. 12 is a schematic diagram illustrating an example of SSB associated with the first actual RO according to an embodiment of the present application.

FIG. 13 is a schematic diagram illustrating another example of SSB associated with the first actual RO according to an embodiment of the present application.

FIG. 14 is a schematic diagram illustrating yet another example of SSB associated with the first actual RO according to an embodiment of the present application.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present application are merely for describing the purpose of the certain embodiment, but not to limit the disclosure.

Multiple PRACH transmissions with different beams or same beam for 4-step RACH were approved in RAN #94 meeting; however, in current version (Rel-17) of 3GPP specification, a RACH occasion (RO) is indicated by SIB1 and a PRACH sequence only occupies a RACH occasion and does not repeat. The UE starts a random access response window (e.g., ra-Response Window configured in RACH-ConfigCommon) to monitor random access response (from gNB) at the first PDCCH occasion as specified in TS 38.213 from the end of the Random Access Preamble transmission. However, when PRACH repetition is enabled, how the UE starts the ra-ResponseWindow and the RAR window size should be determined. e.g., based on the first RACH repetition or the last RACH repetition.

Furthermore, when multiple PRACH transmissions with different beams for 4-step RACH are enabled, to avoid ambiguity between the base station (e.g., gNB) and UEs, the relationship between SSBs and ROs should be determined.

Moreover, when PRACH repetition with multiple beams transmission is enabled, no matter a modified relationship between SSBs and PRACH repetition ROs or a legacy mechanism for determining the relationship between SSBs and PRACH repetition ROs is used, how the base station (e.g., gNB) knows which beam is the better/best beam for DL reception needs to be determined. If the SSB index is not made aware by the base station, then a beam sweeping for RAR will be needed.

Above all, PRACH coverage enhancement has not been addressed, despite being identified as one of the bottleneck channels in the corresponding studies. PRACH transmission is very important for many procedures, e.g., initial access and beam failure recovery. To achieve better coverage performance, some enhancement methods will be needed. This disclosure proposes some enhanced methods for PRACH coverage enhancement or UL coverage enhancement.

The invention of this disclosure can be summarized as below:
1. Methods to determine a random access response window (e.g., ra-Response Window):
The start of the ra-ResponseWindow is at the first PDCCH occasion from the end of the first PRACH repetition, and the size of ra-ResponseWindow is equal to the value configured by gNB.
The start of the ra-ResponseWindow is at the first PDCCH occasion from the end of the last PRACH repetition, and the size of ra-Response Window is equal to the value configured by gNB.
The start of the ra-ResponseWindow is at the first PDCCH occasion from any one PRACH repetition between the first PRACH repetition and the last PRACH repetition, and the size of ra-ResponseWindow is equal to the value configured by gNB.
Multiple timing relationship will be used for PRACH repetition, in other words, multiple ra-ResponseWindows for PRACH repetition will be supported, each PRACH repetition will be triggered a corresponding ra-Response Window.
2. Methods to determine the relationship between SSBs and ROs:
A SSB is mapped to a group of ROs, the information of group of ROs is indicated by gNB.
3. Methods to enable the base station to know which beam is the better/best beam for DL reception:
The SSB associated with the first actual ROs among all of the SSBs within PRACH repetition duration is the better/best DL reception SSB.
The SSB associated with the last actual ROs among all of the SSBs within PRACH repetition duration is the better/best DL reception SSB.
A SSB associated with any one of actual RO between the first RO and the last RO among all of the SSBs within PRACH repetition duration is the better/best DL reception SSB.

FIG. 1 illustrates that, in some embodiments, one or more user equipments (UEs) 10 and a base station (e.g., gNB or eNB) 20 for wireless communication in a communication network system 30 according to an embodiment of the present application are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

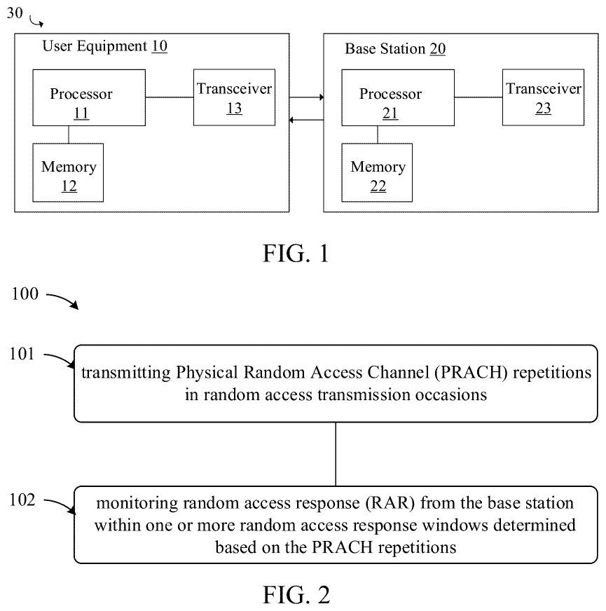

FIG. 2 illustrates a coverage enhancement method according to an embodiment of the present application. Rreferring to FIG. 2 in conjunction with FIG. 1, the method 100 includes the following.

In Step 101, the UE 10 transmits to the base station 20 Physical Random Access Channel (PRACH) repetitions in random access transmission occasions. The UE may perform random access transmission (e.g., random access preamble transmission) to the base station during a random access procedure, and PRACH repetitions are transmitted in the random access transmission occasions.

In Step 102, the UE 10 monitors random access response (RAR) from the base station 20 within one or more random access response windows determined based on the PRACH repetitions. After receiving the random access transmission, the base station transmits and the UE monitors the RAR within one or more random access response windows. The one or more random access response windows are determined based on the PRACH repetitions, for example, based on the first one of the PRACH repetitions (i.e., the first PRACH repetition), the last one of the PRACH repetitions (i.e, the last PRACH repetition), or any one between the first one and the last one of the PRACH repetitions.

In current version (Rel-17) of 3GPP specification, the UE starts a random access response window (e.g., ra-ResponseWindow configured in RACH-ConfigCommon) at the first PDCCH occasion as specified in TS 38.213 from the end of the Random Access Preamble transmission.

This disclosure proposes method(s) to support multiple PRACH transmissions with the same or multiple beams for RACH. When PRACH repetition is enabled, if the random access response window (e.g., ra-ResponseWindow) is started at the the first PDCCH occasion from the end of the first PRACH repetition transmission occasion, then the UE needs to receive random access response (RAR) from the base station during the PRACH repetition. In addition, the end of the ra-ResponseWindow also needs to be determined, e.g., based on the size of ra-ResponseWindow or based on both the size of ra-responsedWindow and the number of PRACH repetitions. Thus, how to determine the ra-ResponseWindow needs to be studied, including the start of ra-Response Window and the size of the ra-Response Window. The following approaches can be considered.

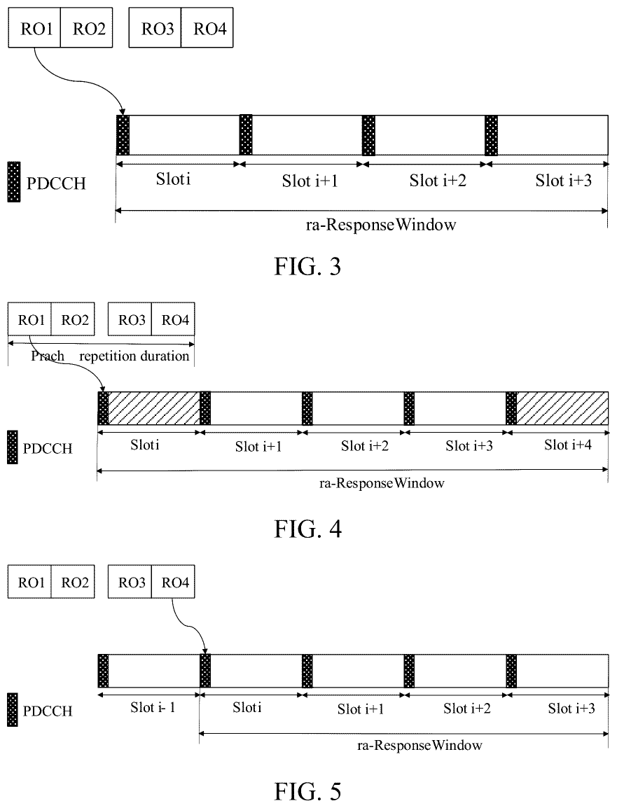

In a first possible implementation, the start of the ra-ResponseWindow is at the first PDCCH occasion from the end of the first PRACH repetition, and the size of ra-Response Window is equal to the value configured by the base station (e.g., gNB). For instance, as shown in FIG. 3, if PRACH repetition is enabled and the number of repetitions of PRACH is configured as 4 (PRACH repetitions on RO1, RO2, RO3, RO4 in order). The ra-ResponseWindow size is configured as 4 slots by the base station (denoted as slot i, slot i+1, slot i+2, slot i+3). Each slot within the ra-ResponseWindow has a PDCCH. When the UE transmits RACH sequence at RO1 and repeats 4 times, the first PRACH repetition is transmited on RO1, the ra-Response Window starts at the PDCCH occasion within slot i and the end of ra-response Window is at slot i+3 (the last symbol in slot i+3).

In some embodiments, the start of ra-Response Window is at the first PDCCH occaison from the end of the the first PRACH repetition, and the size of ra-Response Window is larger than the value which is configured by the base station. The actual size of ra-Response Window is equal to the value configured by the base station plus overlapped time domain (the granularity is slot, that is, the size of overlapped time domain is determined based on unit of slot, if the overlapped time domain is not a interger slot, then the size of the overlapped time domain is determined by ceil (overlapped time domain duration), where, the size of overlaped time domain is multiples of slot.), where the range of time domain duration from the first repetition RO to the last repetition RO (denoted as Prach repetition duration) overlapped with the ra-responseWindow is the overlapped time domain. For instance, as shown in FIG. 4, if PRACH repetition is enabled and the number of repetitions of PRACH is configured as 4 (PRACH repetition on RO1, RO2, RO3, RO4 in order), each slot within the ra-Response Window has a PDCCH. When the UE transmits RACH sequence at RO1 and repeats 4 times, then the start of ra-Response Window is at the first PDCCH occasion from the slot i. The Prach repetition duration is overlapped with ra-ResponseWindow configured by the base station on slot i, then the total ra-ResponseWindow size is equal to 4+1 (where “1” is the size of the overlapped slot(s)), starting from the slot i to slot i+4.

In a second possible implementation, the start of the ra-Response Window is at the first PDCCH occasion from the end of the last PRACH repetition, and the size of ra-Response Window is equal to the value configured by the base station (e.g., gNB). For instance, as shown in FIG. 5, if PRACH repetition is enabled and the number of repetitions of PRACH is configured as 4 (PRACH repetitions on RO1, RO2, RO3, RO4 in order). The ra-ResponseWindow size is configured as 4 slots (denoted as slot i, slot i+1, slot i+2, slot i+3). Each slot within the ra-ResponseWindow has a PDCCH. When the UE transmits RACH sequence at RO1 and repeats 4 times, the last PRACH is transmited on RO4, the ra-ResponseWindow starts at the PDCCH occasion within slot i and the end of ra-response Window is at slot i+3 (the last symbol in slot i+3).

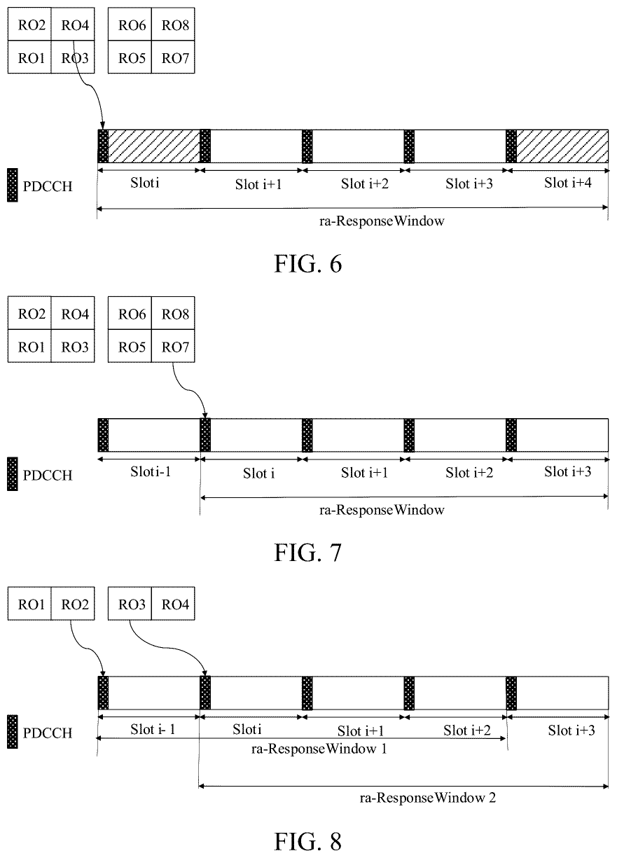

In some embodiments, the start of the ra-Response Window is at the first PDCCH occasion from the end of the last PRACH repetition, and the size of ra-Response Window is equal to the value configured by the base station plus the overlapped time domain. For instance, as shown in FIG. 6, if PRACH repetition is enabled and the number of repetitions of PRACH is configured as 6 (PRACH repetitions on RO1, RO3, RO5, RO7, RO2, RO4, the RO4 is the last PRACH repetition, RO7 is the last PRACH repetition in time domain). The ra-Response Window size is configured as 4 slots. Each slot within the ra-Response Window has a PDCCH. When the UE transmits RACH sequence at RO1 and repeats 6 times (in order of RO1, RO3, RO5, RO7, RO2, RO4), the last PRACH repetition is transmited on RO4, then the ra-Response Window starts at the PDCCH occasion within slot i (behind of RO4) and the end of ra-response Window is at slot i+4 (the last symbol in slot i+4).

In some embodiments, the start of the ra-Response Window is at the first PDCCH occasion from the end of the last PRACH repetition in time domain, and the size of ra-Response Window is equal to the value configured by the base station. For instance, as shown in FIG. 7, if PRACH repetition is enabled and the number of repetitions of PRACH is configured as 6 (PRACH repetitions on RO1, RO3, RO5, RO7, RO2, RO4, the RO4 is the last PRACH repetition, RO7 is the last PRACH repetition in time domain). The ra-ResponseWindow size is configured as 4 slots. Each slot within the ra-Response Window has a PDCCH. When the UE transmits RACH sequence at RO1 and repeats 6 times (in order of RO1, RO3, RO5, RO7, RO2, RO4), the last time domain PRACH repetition is transmited on RO7, then the ra-Response Window starts at the PDCCH occasion within slot i (behind of RO7) and the end of ra-response Window is at slot i+3 (the last symbol in slot i+3).

In a third possible implementation, the start of the ra-ResponseWindow is at the first PDCCH occasion from any one PRACH repetition between the first PRACH repetition and the last PRACH repetition, and the size of ra-ResponseWindow is equal to the value configured by the base station (e.g., gNB). For instance, as shown in FIG. 8, if PRACH repetition is enabled and the number of repetitions of PRACH is configured as 4 (PRACH repetitions with RO1, RO2, RO3, RO4 in order). The ra-ResponseWindow size is configured as 4 slots. Each slot within the ra-ResponseWindow has a PDCCH. In an example, when the UE transmits RACH sequence at RO1 and repeats 4 times, the start of the ra-Response Window is at the first PDCCH occasion from the second PRACH repetition, then the ra-Response Window starts at the PDCCH occasion within slot i−1 and the end of ra-response Window is at slot i+2 (the last symbol in slot i+2), as indicated by ra-Response Window 1 in FIG. 8. In another example, when the UE transmits PRACH sequence at RO1 and repeat 4 times, the start of the ra-Response Window is at the first PDCCH occasion from the third PRACH repetition, then the ra-Response Window starts at the PDCCH occasion within slot i and the end of ra-ResponseWindow is at slot i+3 (the last symbol in slot i+3), as indicated by ra-Response Window 2 in FIG. 8. In some embodiments, the any one PRACH repetition between the first PRACH repetition and the last PRACH repetition is configurable, for example, configured by SIB 1.

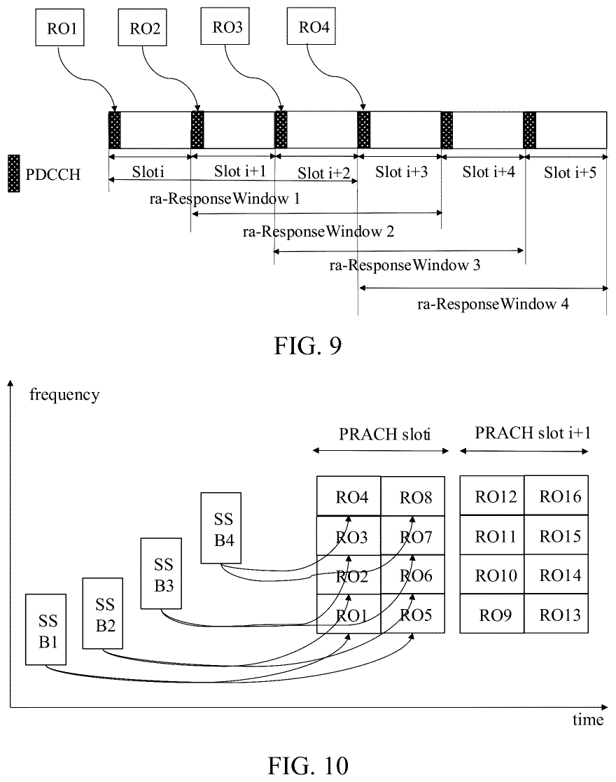

In a fourth possible implementation, multiple timing relationship will be used for PRACH repetition, in other words, multiple ra-Response Windows for PRACH repetition will be supported, each PRACH repetition will trigger a corresponding ra-Response Window. The UE start the ra-ResponseWindow configured in RACH-ConfigCommon at the first PDCCH occasion as specified in TS 38.213 from the end of the corresponding Random Access Preamble transmission. For instance, as shown in FIG. 9, PRACH repetition is enabled and the number of reptitions of PRACH is configured as 4 (PRACH repetitions with RO1, RO2, RO3, RO4 in order). The ra-ResponseWindow size is configured as 3 slots, and each slot within the ra-Response Window has a PDCCH. When the UE transmits RACH sequence at RO1 and repeats 4 times, then 4 corresponding ra-ResponseWindows are triggered, that is, ra-ResponseWindow 1 is associated with RO1, it starts at Slot i and ends at Slot i+2; ra-Response Window 2 is associated with RO2, it starts at Slot i+1 and ends at Slot i+3; ra-Response Window 3 is associated with RO3, it starts at Slot i+2 and ends at Slot i+4; ra-ResponseWindow 4 is associated with RO4, it starts at Slot i+3 and ends at Slot i+5.

The coverage enhancement method may also includes a step of mapping multiple Synchronization Signal Blocks (SSBs) to PRACH repetition RACH occasions (ROs). More specifically, a SSB is mapped to a group of ROs, and the group of ROs are within PRACH repetition duration.

During cell search procedure Synchronization Signal Blocks (SSBs) are used, where the UE searches for the synchronization signals for getting a cell information to get attach with that cell and accesses radio network services. In current version (Rel-17) of 3GPP specification, for RACH access procedure, the beam information is carried by RACH occasion. When PRACH repetition with multiple beams transmission is enabled, the relationship between multiple Synchronisation Signal Blocks (SSBs) and multiple PRACH repetitons should be determined. This disclosure propose method(s) to determine the relationship between multiple SSBs and multiple PRACH transmission occasions.

In one possible implementation, a SSB is mapped to a group of ROs, the information of group of ROs is indicated by the base station (e.g., gNB), for example, by SIB 1. In an embodiment, a new information element (IE) is added in SIB1, and this IE is used for indicating the size of group of ROs. For instance, a new IE “GroupOfRO” is added into “RACH-ConfigGeneric” or “RACH-ConfigGenericTwoStepRA”. The purpose of the IE is used to indicate the size of group of ROs. In another embodiment, a new column is added into the “Random access configurations” table defined in TS 38.211, where the new column is used for indicating the size of group of ROs. In some embodiments, SSBs are mapped to ROs based on PRACH repetitions first. For instance, as shown in FIG. 10, 2 time domain ROs within a RACH slot and 4 frequency-division multiplexing (FDM) ROs are configured by SIB1. The index of the ROs is 1 to 16. When the number of repetitions for PRACH is configured as 4 by the base station, the size of a group of ROs is 2.

In some cases, if the PRACH repetitions can not cross the boundary of PRACH slot and the PRACH repetitions are based on time domain ROs first (PRACH repetitions at {RO1, RO5, RO2, RO6 in order} or {RO3, RO7, RO4, RO8 in order}). The time domain ROs mean the ROs which have the same frequency resources and different time resources. Then, SSB 1 is mapped to RO1 and RO5, SSB2 is mapped RO2 and RO6, SSB 3 is mapped to RO3 and RO7, and SSB 4 is mapped to RO4 and RO8. The SSBs are cycled among the remain ROs if there are some remaining ROs after the first round of SSB cycling.

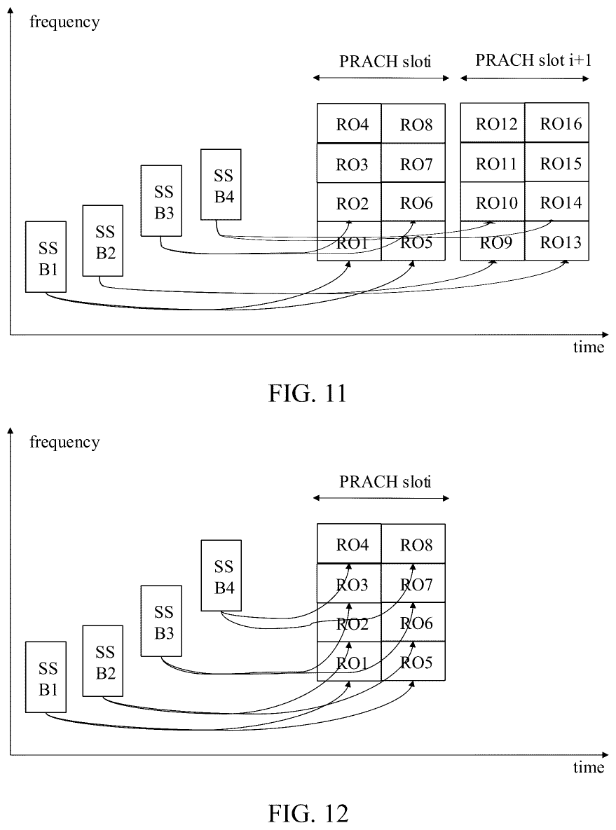

In some cases, if the PRACH repetitions can cross the boundary of PRACH slot and the PRACH repetitions are based on time domain ROs first (PRACH repetition at {RO1, RO5, RO9, RO13 in order}) or {RO2, RO6, RO10, RO14 in order} or {RO3, RO7, RO11, RO15 in order} or {RO4, RO8, RO12, RO16 in order}, as shown in FIG. 11. The time domain ROs mean the ROs which have the same frequency resources and different time resources. Then, SSB1 is mapped to RO1 and RO5, SSB2 is mapped to RO9 and RO13, SSB3 is mapped to RO2 and RO6, and SSB1 is mapped to RO10 and RO14. The SSBs are cycled among the remain ROs if there are some remaining ROs after the first round of SSB cycling.

In some cases, if the PRACH repetitions can not cross the boundary of PRACH slot and the PRACH repetitions are based on frequency domain ROs first (PRACH repetitions at {RO1, RO2, RO3, RO4 in order} or {RO5, RO6, RO7, RO8 in order}). The frequency domain ROs mean the ROs which have the same time resources and different frequency resources. Then, SSB1 is mapped to RO1 and RO2, SSB2 is mapped to RO3 and RO4, SSB3 is mapped to RO5 and RO6, and SSB1 is mapped to RO7 and RO8. The SSBs are cycled among the remain ROs if there are some remaining ROs after the first round of SSB cycling.

In some embodiments, the size of a group of ROs is smaller than the number of reptitions for PRACH when PRACH repetition is enabled. In some embodiments, the size of a group of ROs is equal to the number of PRACH repetitions.

In some embodiments, if the parameter of PRACH repetition is not configured or the size of the PRACH repetition is equal to 1, then legancy relationship between SSBs and ROs could be reused. In some embodiments, the size of group of ROs can be determined based on the number of PRACH repetitions, for example, the size of group of ROs is equal to the number of PRACH repetititions.

Since the SSB is mapped to a group of ROs and the group of ROs can be configured to be smaller than or equal to the number of PRACH repetitions, it is flexible to map multiple SSBs to multiple PRACH transmission occasions, allowing the base station to have flexible resource control.

The coverage enhancement method may also includes a step of enabling the base station to know which beam is the better or best beam for downlink (DL) reception. More specifically, a SSB associated with the first actual RO on which a RACH sequence is first transmited, or the last actual RO on which a RACH sequence is last transmited, or ny one of actual ROs between the first RO on which a RACH sequence is first transmited and the last RO on which the RACH sequence is last transmited is the better or best DL reception SSB.

When PRACH repetition with multiple beams transmission is enabled, no matter a modified relationship between Synchronisation Signal Block (SSBs) and PRACH repetition ROs or a legacy mechanism for determining the relationship between SSBs and PRACH repetition ROs is used, how the base station knows which beam is the better/best beam for DL reception is important. If the SSB index does not achieved by gNB, then a beam sweeping for RAR will be needed. The following approaches can be considered for informing the SSB index.

In a first possible implementation, the SSB associated with the first actual ROs (on which a RACH sequence is transmited) among all of the SSBs within PRACH repetition duration is the better/best DL reception SSB. The base station detects RACH sequence on the ROs. The SSB index carried by the first actual transmission RO among the ROs of PRACH repetition is the better/best DL reception SSB index. The actual transmission RO means there is a RACH sequence transmited on the RO. In a case that PRACH repetition is enabled and the number of reptitions of PRACH is configured as 8 (PRACH repetitions with RO1, RO5, RO2, RO6, RO3, RO7, RO4, RO8 in order, time domain RO first), as shown in FIG. 12, SSB 1 is mapped to RO1 and RO5, SSB2 is mapped to RO2 and RO6, SSB 3 is mapped to RO3 and RO7, and SSB 4 is mapped to RO4 and RO8. If the base station detects RACH sequence from RO2 (that is the first actual RO, UE repeats RACH sequence on RO2, RO6, RO3, RO7, RO4, RO8 in order, the actual number of repetitions is 6), then it means the best beam for DL reception (SSB) is SSB 2. If the base station detects RACH sequence from RO1 (UE repeats RACH sequence on RO1, RO5, RO2, RO6, RO3, RO7, RO4, RO8 in order, the actual number of repetitions is 8, which is equal to the configured number), then it means the best beam for DL reception is SSB 1. If the base station detects RACH sequence from RO4 (that is the first actual RO, UE repeats RACH sequence on RO4, RO8 in order, the actual number of repetitions is 2), then it means the best beam for DL reception is SSB 4.

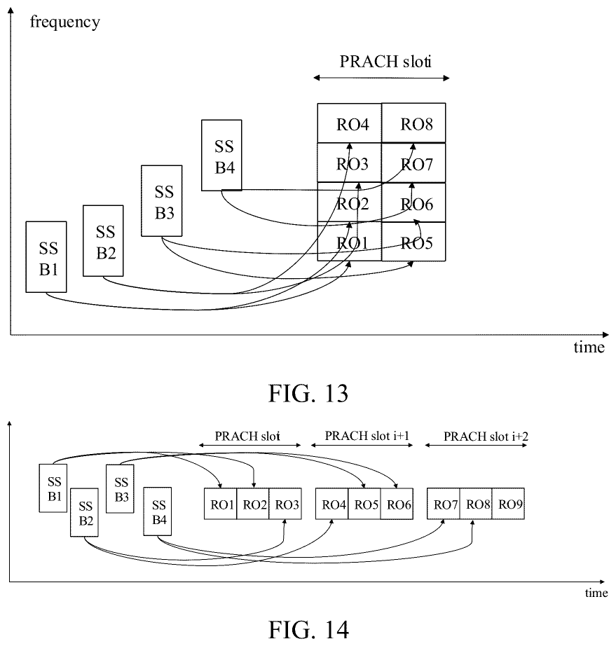

In a case that PRACH repetition is enabled and the number of reptitions of PRACH is configured as 8 (PRACH repetitions with RO1, RO2, RO3, RO4, RO5, RO6, RO7, RO8 in order, frequency domain RO first), as shown in FIG. 13, SSB 1 is mapped to RO1 and RO2, SSB2 is mapped to RO3 and RO4, SSB 3 is mapped to RO5 and RO6, and SSB 4 is mapped to RO7 and RO8. If the base station detects RACH sequence from RO2 (that is the first actual RO, UE repeats RACH sequence on RO2, RO3, RO4, RO5, RO6, RO7, RO8 in order, the actual number of repetitions is 7), then it meams the best beam for DL reception (SSB) is SSB 1. If the base station detects RACH sequence from RO7 (that is the first actual RO, UE repeats RACH sequence on RO7, RO8 in order, the actual number of repetitions is 2), then it meams the best beam for DL reception (SSB) is SSB 4.

In a case that PRACH repetition is enabled and the number of reptitions of PRACH is configured as 8 (PRACH repetitions with RO1, RO2, RO3, RO4, RO5, RO6, RO7, RO8 in order, time domain ROs only), as shown in FIG. 14. SSB1 is mapped to RO1 and RO2, SSB2 is mapped to RO3 and RO4, SSB3 is mapped to RO5 and RO6, and SSB 4 is mapped to RO7 and RO8. If the base station detects RACH sequence from RO4 (that is the first actual RO, UE repeats RACH sequence on RO4, RO5, RO6, RO7, RO8 in order, the actual number of repetitions is 5), then it meams the best beam for DL reception (SSB) is SSB 2. If the base station detects RACH sequence from RO7 (that is the first actual RO, UE repeats RACH sequence on RO7, RO8 in order, the actual number of repetitions is 2), then it meams the best beam for DL reception (SSB) is SSB 4.

In a second possible implementation, the SSB associated with the last actual RO (on which a RACH sequence is transmited) among all of the SSBs within PRACH repetition duration is the better/best DL reception SSB. The base station detects RACH sequence on the ROs. The SSB index carried by the last actual transmission RO among the ROs of PRACH repetition is the better/best DL reception SSB index. The actual transmission RO means there is a RACH sequence transmited on the RO. In a case that PRACH repetition is enabled and the number of reptitions of PRACH is configured as 8 (PRACH repetitions with RO1, RO5, RO2, RO6, RO3, RO7, RO4, RO8 in order, time domain RO first), referring to FIG. 12, SSB 1 is mapped to RO1 and RO5, SSB2 is mapped to RO2 and RO6, SSB 3 is mapped to RO3 and RO7, SSB 4 is mapped to RO4 and RO8. If the base station detects RACH sequence from RO2 to RO8, then it meams the best beam for DL reception (SSB) is SSB 4. If the base station detects RACH sequence from RO6 to RO8, then it meams the best beam for DL reception (SSB) is SSB 4. If the base station detects RACH sequence from RO1 to RO4, then it means the best beam for DL reception (SSB) is SSB2. In some embodiments, UE can end the PRACH repetitions before the last repetition configured by gNB.

In a third possible implementation, a SSB associated with any one of actual ROs between the first RO and the last RO among all of the SSBs within PRACH repetition duration is the better/best DL reception SSB. The base station detects RACH sequence on the ROs, and the SSB index carried by one of the actual transmission ROs among the ROs of PRACH repetition is the better/best DL reception SSB index. The actual transmission RO means there is a RACH sequence transmited on the RO. In some embodiments, the location of the RO is configurable, for example, configured by SIB1. In an embodiment, a new IE is added into SIB1, and this IE is used to indicate the lacation of the RO. A new IE “LocationOfRO” can be added into “RACH-ConfigGeneric” or “RACH-ConfigGenericTwoStepRA”. The purpose of the IE is used to indicate the lacation of the RO. For instance, when the number of reptitions of PRACH is configured as 6 (repeat on RO1, RO2, RO3, RO4, RO5, RO6 in order), the size of group of ROs is configured as 3, two SSBs are used, SSB1 is mapped to {RO1, RO2, RO3}, SSB2 is mapped to {RO4, RO5, RO6}, the location of the RO is indicated as 4 (index from 0 to 5), then it means the SSB 2 is the best/better SSB. In another embodiment, a new column is added into the “Random access configurations” table defined in TS 38.211, where the new column is used for indicating the the location of the RO. In some embodiments, a RO offset can be configured to UE by the base station, and the SSB associated with the offset RO is the best/better DL reception SSB. The RO offset value can be indicated by SIB1. In an embodiment, a new IE “offsetOfRO” can be added into “RACH-ConfigGeneric” or “RACH-ConfigGenericTwoStepRA”. In another embodiment, a new column is added into the “Random access configurations” table defined in TS 38.211, where the new column is used for indicating the value of the RO offset. The candidate values of the RO offset can be an interger. The RO offset can be based on the first RO configured by the base station or the first actual RO within the duration of PRACH repetitions. For instance, referring to FIG. 14, if the value of RO offset is configured as 3 and based on the first RO configured by the base station, and if PRACH repetitons are RO1, RO2, RO3, RO4, RO5, RO6, RO7, RO8, then it means the SSB associated with RO 4 is the best DL reception SSB and the SSB's index is 2.

Commercial interests for some embodiments are as follows. 1. Solving issues in the prior art. 2. Carrying out coverage enhancement. 3. Achieving better coverage performance. 4. Realizing determination on the start and the size of random access response window. 5. Realizing mapping between multiple SSBs and multiple PRACH transmission occasions. 6. Enabling the base station to know which beam is the better or best beam for DL reception. 7. Providing a good communication performance. Some embodiments of the present application are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present application are a combination of “techniques/processes” that can be adopted in 3GPP specification to create an end product. Some embodiments of the present application could be adopted in the 5G NR unlicensed band communications. Some embodiments of the present application propose technical mechanisms.

The embodiment of the present application further provides a computer readable storage medium for storing a computer program. The computer readable storage medium enables a computer to execute corresponding processes implemented by the UE/BS in each of the methods of the embodiment of the present application. For brevity, details will not be described herein again.

The embodiment of the present application further provides a computer program product including computer program instructions. The computer program product enables a computer to execute corresponding processes implemented by the UE/BS in each of the methods of the embodiment of the present application. For brevity, details will not be described herein again.

The embodiment of the present application further provides a computer program. The computer program enables a computer to execute corresponding processes implemented by the UE/BS in each of the methods of the embodiment of the present application. For brevity, details will not be described herein again.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different approaches to implement the described functions for each particular application, but it should not be considered that the implementation goes beyond the scope of the present application.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1. A coverage enhancement method, performed by a user equipment (UE) communicating with a base station (BS), the method comprising:
transmitting Physical Random Access Channel (PRACH) repetitions in random access transmission occasions; and
monitoring random access response (RAR) from the base station within one or more random access response windows determined based on the PRACH repetitions.

2. The method of claim 1, wherein the start of the random access response window is at the first Physical Downlink Control Channel (PDCCH) occasion from the end of the first PRACH repetition.

3. The method of claim 1, wherein the start of the random access response window is at the first PDCCH occasion from the end of the last PRACH repetition.

4. The method of claim 3, wherein the last PRACH repetition is the last PRACH repetition in time domain.

5. The method of claim 1, wherein the start of the random access response window is at the first PDCCH occasion from any one PRACH repetition between the first PRACH repetition and the last PRACH repetition.

6. The method of claim 1, wherein the size of the random access response window is equal to a configured value.

7. The method of claim 1, wherein the size of the random access response window is larger than a configured value.

8. The method of claim 7, wherein the size of the random access response window is equal to the configured value plus the size of overlapped time domain, and the overlapped time domain is PRACH repetition duration overlapped with the random access response window.

9-23. (cancelled)

24. A coverage enhancement method, performed by a base station (BS) communicating with a user equipment (UE), the method comprising:
receiving from the UE Physical Random Access Channel (PRACH) repetitions in random access transmission occasions; and
transmitting random access response (RAR) within one or more random access response windows determined based on the PRACH repetitions.

25. The method of claim 24, wherein the start of the random access response window is at the first Physical Downlink Control Channel (PDCCH) occasion from the end of the first PRACH repetition.

26. The method of claim 24, wherein the start of the random access response window is at the first PDCCH occasion from the end of the last PRACH repetition.

27. The method of claim 26, wherein the last PRACH repetition is the last PRACH repetition in time domain.

28-40. (canceled)

41. A user equipment (UE), communicating with a base station (BS) in a network, the UE comprising a processor, configured to call and run program instructions stored in a memory, to execute a coverage enhancement method, wherein the coverage enhancement method comprises:
transmitting Physical Random Access Channel (PRACH) repetitions in random access transmission occasions; and
monitoring random access response (RAR) from the base station within one or more random access response windows determined based on the PRACH repetitions.

42-45. (canceled)

46. The UE of claim 41, wherein the start of the random access response window is at the first Physical Downlink Control Channel (PDCCH) occasion from the end of the first PRACH repetition.

47. The UE of claim 41, wherein the start of the random access response window is at the first PDCCH occasion from the end of the last PRACH repetition.

48. The UE of claim 47, wherein the last PRACH repetition is the last PRACH repetition in time domain.

49. The UE of claim 41, wherein the start of the random access response window is at the first PDCCH occasion from any one PRACH repetition between the first PRACH repetition and the last PRACH repetition.

50. The UE of-claim 41, wherein the size of the random access response window is equal to a configured value.

51. The UE of claim 41, wherein the size of the random access response window is larger than a configured value.

52. The method of claim 1, further comprising:
mapping multiple Synchronization Signal Blocks (SSBs) to PRACH repetition RACH occasions (ROs), wherein a SSB is mapped to a group of ROs, and a size of the group of ROs is determined based on a number of the PRACH repetitions.
